(19) United States
(12) Patent Application Publication
(10) Pub. No.: US 2026/0291843 A1
(43) Pub. Date: Sep. 24, 2026

(54) COMMUNICATION SYSTEM, INFORMATION PROCESSING TERMINAL, AND INFORMATION PROCESSING SYSTEM

(71) Applicant: TOYOTA JIDOSHA KABUSHIKI KAISHA, Toyota-shi (JP)

(72) Inventor: Tsuneo NAKATA, Kamakura-shi (JP)

(73) Assignee: TOYOTA JIDOSHA KABUSHIKI KAISHA, Toyota-shi (JP)

(21) Appl. No.: 19/559,075

(22) Filed: Mar. 6, 2026

(30) Foreign Application Priority Data
Mar. 19, 2025 (JP) 2025-045818

(51) Int. Cl. H04L 43/0894; H04L 43/0882; H04L 47/22

(52) U.S. Cl. CPC H04L 43/0894; H04L 43/0882; H04L 47/22

(57) ABSTRACT

An information processing terminal that transmits data received from an application to an information processing apparatus, the information processing terminal comprising: a processor configured to: determine whether a transmission rate of the application is decreased; and transmit data received after the transmission rate of the application is decreased with priority over data received before the transmission rate of the application is decreased and not transmitted in a case where it is determined that the transmission rate of the application is decreased.

### CROSS-REFERENCE TO RELATED APPLICATION

This application claims priority to Japanese Patent Application No. 2025-045818 filed on Mar. 19, 2025. The disclosure of the above-identified application, including the specification, drawings, and claims, is incorporated by reference herein in its entirety.

### BACKGROUND

### 1. Technical Field

The present disclosure relates to a communication system, an information processing terminal, and an information processing system.

### 2. Description of Related Art

In the technique disclosed in Japanese Unexamined Patent Application Publication No. 2009-5193 (JP 2009-5193 A), in a case where a transmission unit temporarily stops transmission of a frame, the frame accumulated in a transmission buffer for a predetermined residence allowable time or longer is discarded. As a result, it is possible to avoid the transmission of the frame that is not in time for real-time processing.

### SUMMARY

However, in a case of transmitting data from a transmission terminal to a reception terminal, both a delay due to residence in a buffer and a transmission delay between the transmission terminal and the reception terminal have an influence.

In addition, in the technique disclosed in JP 2009-5193 A, the influence of discarding the frame on the application is not considered. Therefore, even in a case where the delay is kept low, a user experience for the application may not be improved.

For example, in a case where the application transmits the data at a bandwidth larger than a bandwidth between the transmission terminal and the reception terminal, the frame is periodically discarded in the method disclosed in JP 2009-5193 A. In a case where the reception terminal cannot decode the data transmitted by the application from the received frame (the frame that is not discarded), the transmission of the data from the application is not successful even in a case where the delay is resolved. As a result, there is a problem that a user cannot experience the function of the application.

The present disclosure has been made in view of the above, and an object thereof is to provide a communication system, an information processing terminal, and an information processing system capable of improving a user experience for an application.

A communication system according to the present disclosure includes an information processing terminal configured to transmit data received from an application, and

an information processing apparatus configured to execute processing based on the data received from the information processing terminal, in which

the information processing terminal includes a first processor configured to:

determine whether a transmission rate of the application is decreased; and

transmit, in a case where determination is made that the transmission rate of the application is decreased, data received after the decrease in the transmission rate of the application with priority over data that is not transmitted and is received before the decrease in the transmission rate of the application, and

the information processing apparatus includes a second processor configured to receive the data after the decrease in the transmission rate of the application from the information processing terminal and execute processing based on the received data.

An information processing terminal according to the present disclosure is an information processing terminal configured to transmit data received from an application to an information processing apparatus, the information processing terminal including a processor configured to:

determine whether a transmission rate of the application is decreased; and

transmit, in a case where determination is made that the transmission rate of the application is decreased, data received after the decrease in the transmission rate of the application with priority over data that is not transmitted and is received before the decrease in the transmission rate of the application.

In the information processing terminal according to the present disclosure, the processor is configured to determine that the transmission rate of the application is decreased, in a case where a reception rate of the information processing terminal is decreased.

In the information processing terminal according to the present disclosure, the processor is configured to determine that the transmission rate of the application is decreased, in a case where notification that the transmission rate of the application is decreased is received from the application.

In the information processing terminal according to the present disclosure, the processor is configured to determine that the transmission rate of the application is decreased, in a case where a reception rate of the information processing terminal exceeds a bandwidth of a network between the information processing terminal and the information processing apparatus.

An information processing system according to the present disclosure includes

the information processing terminal, and

a terminal device on which the application is installed,

in which, in a case where line congestion information is received from the information processing terminal,

the application is configured to:

stop transmission at a current transmission rate;

transmit the notification that the transmission rate of the application is decreased to the information processing terminal; and

resume transmission by decreasing the transmission rate.

According to the present disclosure, it is possible to realize the communication system, the information processing terminal, and the information processing system capable of improving the user experience for the application.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a communication system including a vehicle and a server;

FIG. 2 is a timing chart showing processing of the communication system shown in FIG. 1;

FIG. 3 is a flowchart showing processing executed by a DCM according to Example 1;

FIG. 4 is a flowchart showing processing executed by a DCM according to Example 2;

FIG. 5 is a flowchart showing processing executed by a DCM according to Example 3;

FIG. 6 is a flowchart showing processing executed by an ECU;

FIG. 7 is a timing chart showing processing of a communication system including an information processing terminal according to Embodiment 2; and

FIG. 8 is a timing chart showing processing of a communication system of a comparative example.

### DETAILED DESCRIPTION OF EMBODIMENTS

The communication system, the information processing terminal, and the information processing system according to the embodiment of the present disclosure will be described with reference to the drawings. It should be noted that the components in the following embodiments include those that can be replaced and easily replaced by those skilled in the art or are substantially the same.

### Embodiment 1

### Communication System

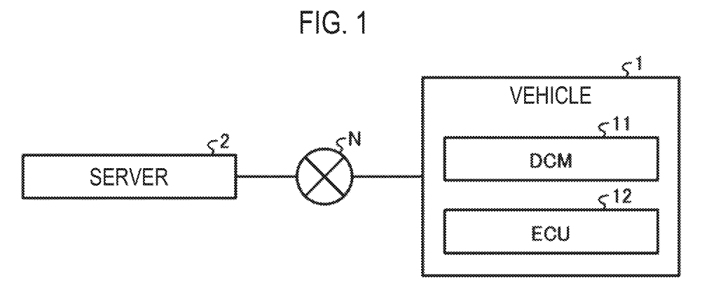

FIG. 1 is a block diagram showing a configuration of a communication system including a vehicle and a server. The communication system shown in FIG. 1 includes a vehicle 1 as an information processing system and a server 2 as an information processing apparatus. It should be noted that, here, the communication between the vehicle 1 and the server 2 will be described as an example, but the communication system may include any terminal and can be applied to all communication.

Both the vehicle 1 and the server 2 are configured to have a communication function and to communicate with each other through a network N to exchange various types of information. The network N is configured by, for example, a public line network such as an Internet line network and a mobile phone line network. The network N may include wireless communication such as Wi-Fi (registered trademark, Wireless Fidelity) and Bluetooth (registered trademark) Low Energy (BLE), a satellite line via a satellite, and the like.

The vehicle 1 includes a data communication module (DCM) 11 as an information processing terminal and an electronic control unit (ECU) 12 as a terminal device. It should be noted that, hereinafter, an example will be described in which the vehicle 1 includes the DCM 11 and the ECU 12, but the ECU 12 may have the function of the DCM 11.

The DCM 11 mainly includes a microcomputer including a first processor consisting of, for example, a central processing unit (CPU) and a memory consisting of a read only memory (ROM) and a random access memory (RAM). The DCM 11 exchanges information with the server 2 by communication via the network N. The DCM 11 transmits the data received from the application of the ECU 12 to the server 2.

The ECU 12 mainly includes a microcomputer including a processor consisting of, for example, a CPU and a memory consisting of a ROM and a RAM. A streaming type application (hereinafter, also referred to as an “application” or “App”) such as a video conference application is installed in the ECU 12.

The server 2 is realized by, for example, a general-purpose computer such as a workstation or a personal computer including a second processor consisting of, for example, a CPU and a memory consisting of a ROM and a RAM. In a case where the server 2 receives the data from the vehicle 1, the server 2 transmits an acknowledgment (hereinafter, also referred to as “Ack”) for delivery.

### Processing of Communication System

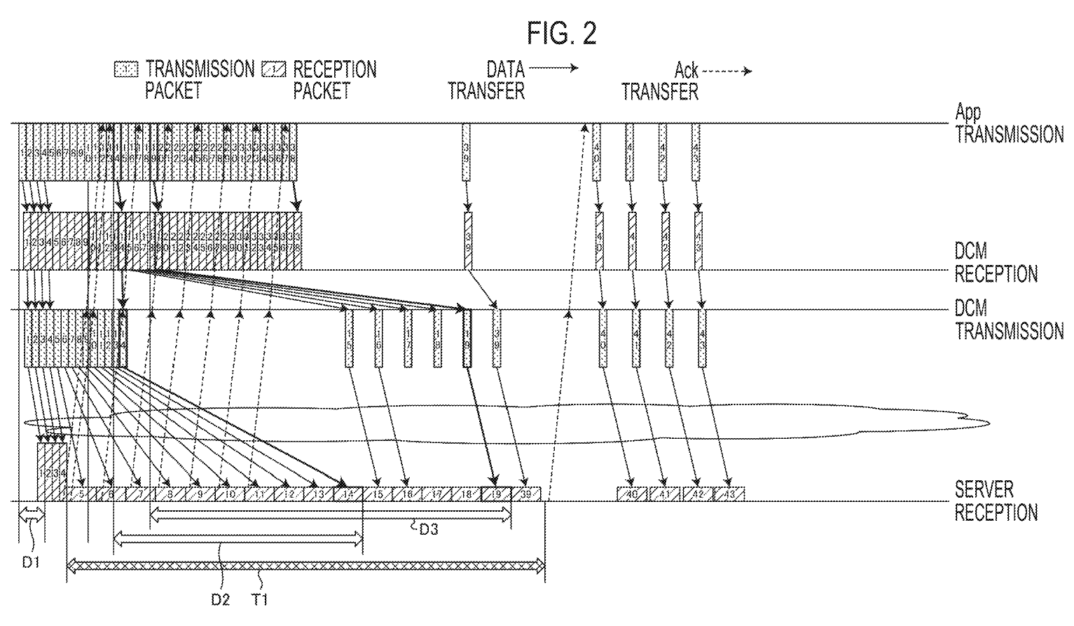

FIG. 2 is a timing chart showing the processing of the communication system shown in FIG. 1. A horizontal axis of FIG. 2 is a time axis. Then, from the top row of FIG. 2, data transmitted from the application (App) to the DCM 11, data received from the application by the DCM 11, data transmitted from the DCM 11 to the server 2, and data received from the DCM 11 by the server 2 are shown. The data is transmitted in units of packets, an area of each packet corresponds to a data amount, and sequence numbers are assigned to each packet in time series.

First, the transmission is started in a state where the transmission rate of the application is high. A delay D1 until the packet of the sequence number 1 is received from the application to the server 2 via the DCM 11 is 0.1 s.

Thereafter, in a case where the packet of the sequence number 5 is transmitted from the DCM 11 to the server 2, it is assumed that the line speed of the network N is reduced to 1/4. As a result, the delay is accumulated over time.

Here, the application installed in the ECU 12 detects the congestion of the network N by the acknowledgment (Ack) from the server 2. In a case where the application transmits the packet of the sequence number 12, the application receives the acknowledgment of the sequence number 3. Similarly, in a case where the application transmits the packet of the sequence number 13, the application receives the acknowledgment of the sequence number 4. However, in a case where the application transmits the packet of the sequence number 14, the application cannot receive the next acknowledgment. In this case, the application detects the congestion of the network N. Then, in a case where the application notifies the DCM 11 of the detection of the congestion, the DCM 11 temporarily stops the transmission of the data in order to wait for the congestion state to be resolved. It should be noted that a delay D2 until the packet of the sequence number 14 before the resumption of the transmission is received by the server 2 is 1 s.

Thereafter, in a case where the application transmits the packet of the sequence number 17, the application receives the acknowledgment of the sequence number 5. As a result, the application calculates the reception rate of the server 2 from the time from the acknowledgment of the sequence number 4 to the acknowledgment of the sequence number 5. Then, in a case where the application transmits the packet of the sequence number 19, the reception rate of the server 2 is transmitted to the DCM 11. As a result, the DCM 11 resumes the transmission of the data from the packet of the sequence number 15 at the transmission rate corresponding to the reception rate of the server 2.

Then, since the congestion state of the network N is not resolved for a predetermined time, the application starts the transmission by decreasing the transmission rate of the application from the packet of the sequence number 39. As a result, since the reception rate of the DCM 11 is decreased, the DCM 11 determines that the transmission rate of the application is decreased. In this case, the DCM 11 transmits the data received after the decrease in the transmission rate of the application with priority over the data received before the decrease in the transmission rate of the application and not transmitted. Specifically, the DCM 11 deletes the packets of the sequence numbers 20 to 38 and starts the transmission by decreasing the transmission rate from the packet of the sequence number 39. As a result, stable communication is performed at a low transmission rate from the packet of the sequence number 39. It should be noted that a delay D3 until the packet of the sequence number 19 before the transmission rate of the DCM 11 is decreased is received by the server 2 is 1.5 s. In addition, a communication quality deterioration period T1 until the packet of the sequence number 39 is received by the server 2 is 1.9 s.

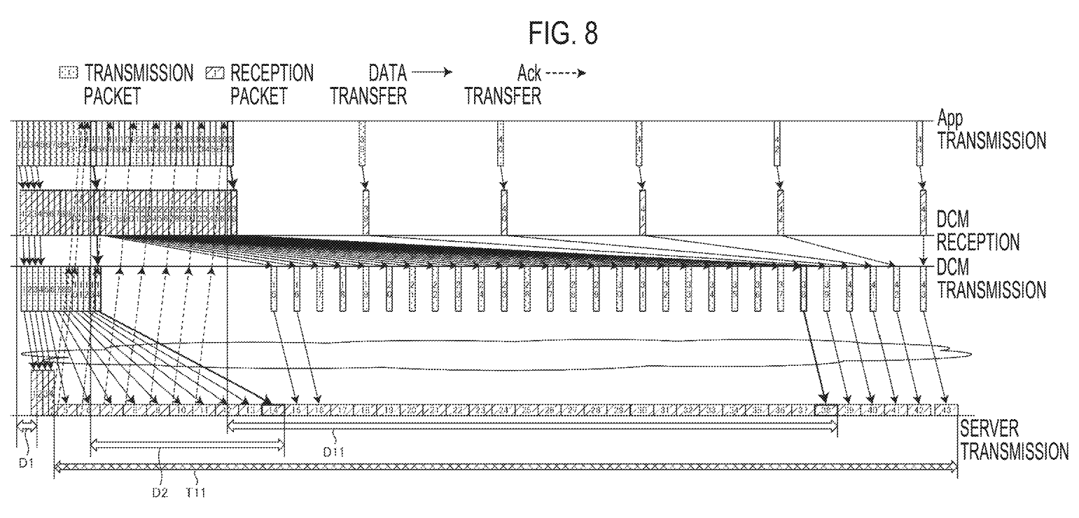

FIG. 8 is a timing chart showing processing of a communication system of a comparative example. In the communication system of the comparative example, the DCM transmits the packets in order of the smaller sequence numbers even after the application starts the transmission by decreasing the transmission rate from the packet of the sequence number 39. In this case, a delay D11 until the packet of the sequence number 38 before the transmission rate of the application is decreased is received by the server is 3 s. In addition, a communication quality deterioration period T11 until the packet of the sequence number 43 is received by the server is 4.5 s.

### Processing of DCM

Next, the processing of transmitting the data received after that with priority in a case where the DCM 11 determines that the transmission rate of the application is decreased will be described in detail.

### Example 1

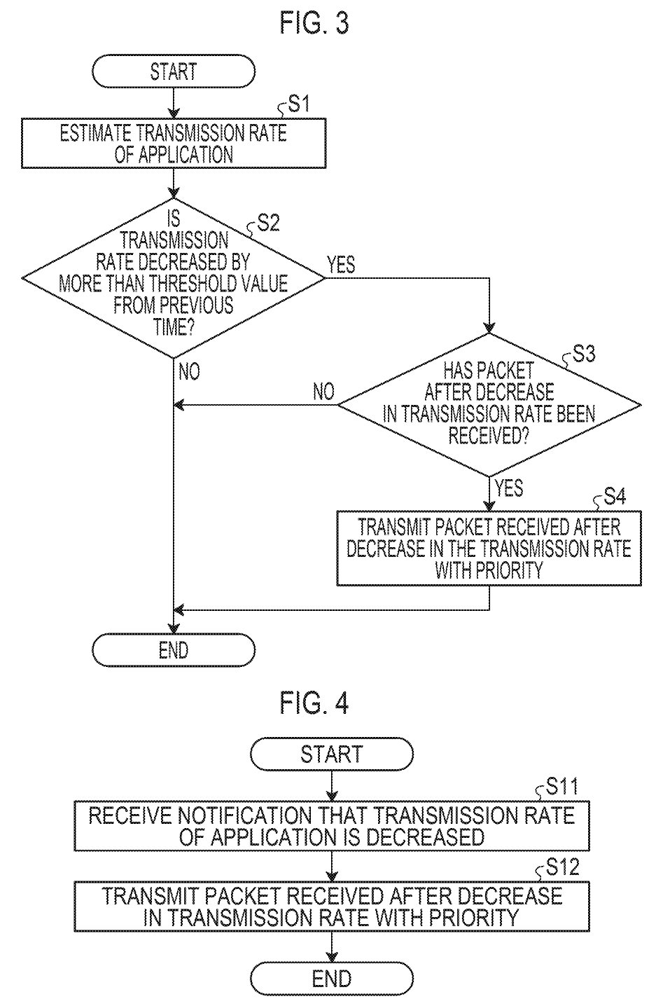

FIG. 3 is a flowchart showing processing executed by the DCM according to Example 1. As shown in FIG. 3, the DCM 11 estimates the transmission rate of the application (S1). Specifically, the DCM 11 estimates the transmission rate of the application based on the reception rate of the DCM 11.

Subsequently, the DCM 11 determines whether the estimated transmission rate of the application is decreased by more than a threshold value from the previously estimated transmission rate of the application (S2). Specifically, the DCM 11 determines that the transmission rate of the application is decreased in a case where the reception rate of the DCM 11 is decreased. In addition, the DCM 11 may determine that the transmission rate of the application is decreased in a case where the reception rate of the DCM 11 exceeds the bandwidth of the network N between the DCM 11 and the server 2.

In a case where the DCM 11 determines that the transmission rate of the application is not decreased (S2: No), the series of processing ends.

On the other hand, in a case where the DCM 11 determines that the transmission rate of the application is decreased (S2: Yes), the DCM 11 determines whether the packet after the decrease in the transmission rate of the application has been received (S3).

In a case where the DCM 11 determines that the packet after the decrease in the transmission rate of the application has not been received (S3: No), the series of processing ends.

On the other hand, in a case where the DCM 11 determines that the packet after the decrease in the transmission rate of the application has been received (S3: Yes), the processing proceeds to S4. In S4, the DCM 11 transmits the data received from the application after the decrease in the transmission rate of the application with priority over the data received before the decrease in the transmission rate of the application and not transmitted. Specifically, as shown in FIG. 2, the DCM 11 deletes the data received before the decrease in the transmission rate of the application and not transmitted, and transmits the data received from the application after the decrease in the transmission rate of the application. The data received before the decrease in the transmission rate of the application and not transmitted is the packets of the sequence numbers 20 to 38. The data received from the application after the decrease in the transmission rate of the application is the packet of the sequence number 39.

Then, the server 2 receives the data after the decrease in the transmission rate of the application from the DCM 11 and executes the processing corresponding to the received data. Since the server 2 can receive all the data of the sequence number 39 or more, the communication is successful, and the processing corresponding to the received data can be executed. As a result, the user can obtain the experience corresponding to the application.

According to Example 1 described above, in a case where the DCM 11 determines that the transmission rate of the application is decreased, the DCM 11 transmits the data received from the application after the decrease in the transmission rate of the application with priority. As a result, the untransmitted packet is prevented from remaining in the DCM 11, and the newly received packet after the decrease in the transmission rate of the application can be transmitted to the server 2. As a result, since the packet after the decrease in the transmission rate of the application is not discarded, the communication is successful, and the user can experience the function of the application. That is, according to Example 1, the user experience for the application can be improved.

It should be noted that, in Example 1, the example has been described in which the DCM 11 determines that the transmission rate of the application is decreased in a case where the reception rate of the DCM 11 is decreased, but the present disclosure is not limited to this. For example, the DCM 11 receives the sequence number for which the acknowledgment is received from the application. Then, the DCM 11 may determine that the transmission rate of the application is decreased in a case where the difference between the sequence number and the sequence number of the latest packet received by the DCM 11 is reduced.

In addition, in Example 1, the example has been described in which the DCM 11 deletes the data received before the decrease in the transmission rate of the application and not transmitted, but the present disclosure is not limited to this. The DCM 11 may store the data received before the decrease in the transmission rate of the application and not transmitted in a storage area other than the transmission waiting queue.

In addition, in a case where the DCM 11 determines that the transmission rate of the application is decreased, the DCM 11 may generate a transmission waiting queue for transmitting the data with higher priority, separately from the transmission waiting queue for storing the data received before the decrease in the transmission rate of the application and not transmitted. Then, the DCM 11 may store the data received from the application after the decrease in the transmission rate of the application in the generated queue.

In addition, in a case where a wide area line such as a satellite line and a Wi-Fi line different from the cellular line can be used in addition to the cellular line, the DCM 11 may determine that the transmission rate of the application is decreased. In this case, the DCM 11 may transmit the data received from the application after the decrease in the transmission rate of the application with priority from a line with less delay. Then, the DCM 11 may transmit the data received before the decrease in the transmission rate of the application and not transmitted from a line with a large delay.

### Example 2

FIG. 4 is a flowchart showing processing executed by the DCM according to Example 2. As shown in FIG. 4, the DCM 11 receives the transmission rate decrease notification of the application from the application (S11). The transmission rate decrease notification includes, for example, flow identification information such as an IP address, a port, and a protocol, the transmission rate after the decrease, a transmission rate decrease start time, and identification information (sequence number or the like) of a transmission rate decrease start packet.

As a result, the DCM 11 determines that the transmission rate of the application is decreased. Then, the DCM 11 deletes the data received before the decrease in the transmission rate of the application and not transmitted, and transmits the data received from the application after the decrease in the transmission rate of the application (S12).

As in Example 2, the DCM 11 may determine that the transmission rate of the application is decreased in a case where the transmission rate decrease notification is received from the application.

### Example 3

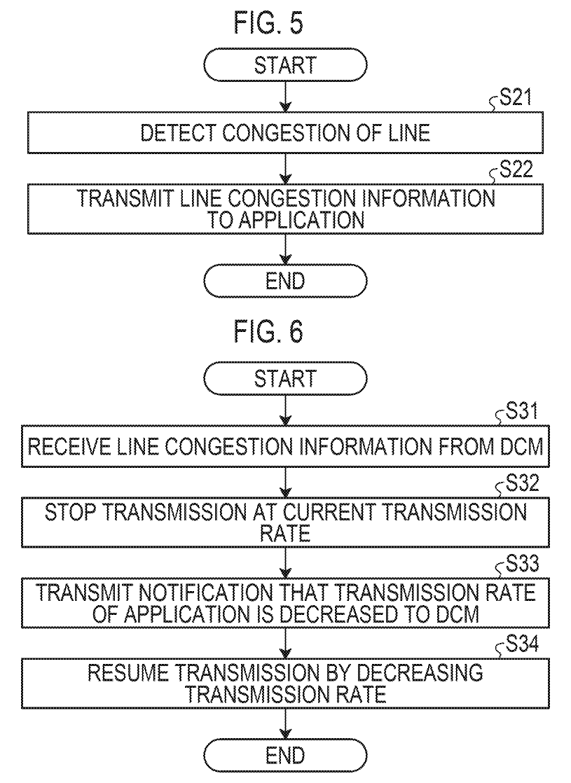

First, the processing in the DCM 11 will be described. FIG. 5 is a flowchart showing processing executed by the DCM according to Example 3. As shown in FIG. 5, the DCM 11 detects the congestion of the line (network N) between the DCM 11 and the server 2 (S21). Specifically, the DCM 11 determines that the network N is in the congestion state in a case where the reception rate of the DCM 11 exceeds the bandwidth of the network N between the DCM 11 and the server 2. In addition, the DCM 11 may determine the congestion in a case where the delay of the data transmitted by the DCM 11 is measured and the delay increases over time. In addition, the DCM 11 may predict the future line state from the position of the vehicle 1 and the wireless area map or the base station congestion information, and predict the occurrence of the congestion.

Subsequently, the DCM 11 transmits the line congestion information to the application (S22).

Subsequently, the processing in the ECU 12 will be described. FIG. 6 is a flowchart showing processing executed by the ECU. As shown in FIG. 6, the application installed in the ECU 12 receives the line congestion information from the DCM 11 (S31).

As a result, the application stops the transmission at the current transmission rate (S32).

Further, the application transmits the transmission rate decrease notification to the DCM 11 (S33).

Then, the application resumes the transmission by decreasing the transmission rate (S34).

Thereafter, the DCM 11 executes the processing shown in FIG. 4 as in Example 2. Specifically, in a case where the DCM 11 receives the transmission rate decrease notification of the application from the application, the DCM 11 determines that the transmission rate of the application is decreased. Then, the DCM 11 deletes the data received before the decrease in the transmission rate of the application and not transmitted, and transmits the data received from the application after the decrease in the transmission rate of the application.

As in Example 3, the DCM 11 may detect the congestion of the network N and output a signal to notify the application to decrease the transmission rate from the DCM 11.

### Embodiment 2

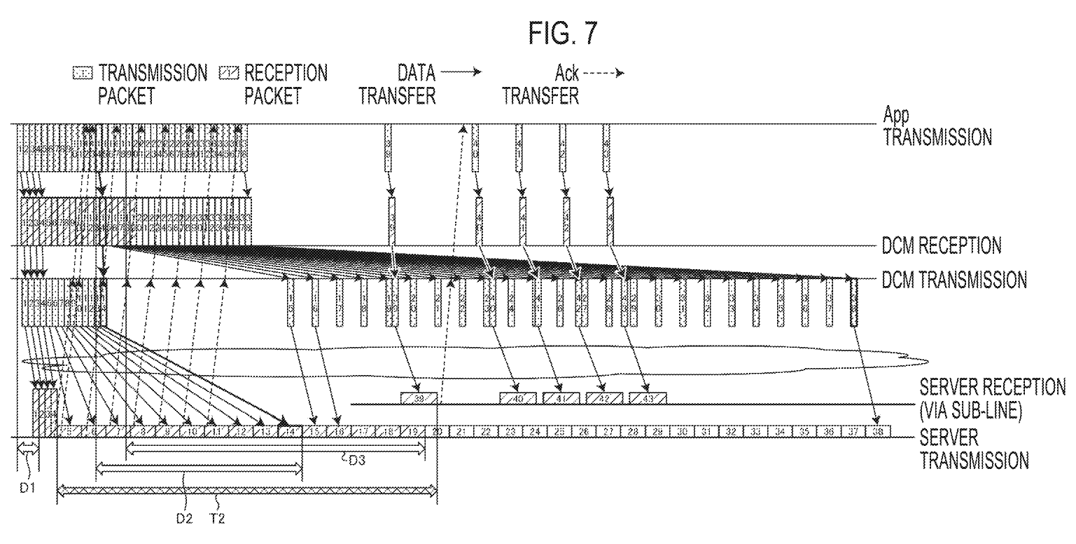

FIG. 7 is a timing chart showing processing of a communication system including the information processing terminal according to Embodiment 2. In the communication system, a wide area line such as a satellite line and a sub-line such as a Wi-Fi line different from the cellular line can be used in addition to the cellular line. In addition, since the configuration of Embodiment 2 may be the same as the configuration of Embodiment 1 shown in FIG. 1, the description thereof will be omitted.

The line speed of the network N is reduced to 1/4 from the packet of the sequence number 5, and the processing executed in response to this is the same as in Embodiment 1, so the description thereof will be omitted. Thereafter, since the congestion state of the network N is not resolved for a predetermined time, the application starts the transmission by decreasing the transmission rate of the application from the packet of the sequence number 39. As a result, since the reception rate of the DCM 11 is decreased, the DCM 11 determines that the transmission rate of the application is decreased. In this case, the DCM 11 transmits the data received after the decrease in the transmission rate of the application with priority over the data received before the decrease in the transmission rate of the application and not transmitted. Specifically, the DCM 11 transmits the data received after the decrease in the transmission rate of the application with priority from the sub-line, and continues to transmit the data received before the decrease in the transmission rate of the application and not transmitted. It should be noted that a communication quality deterioration period T2 until the packet of the sequence number 39 is received is 1.8 s.

As in Embodiment 2, in a case where a plurality of lines can be used, the DCM 11 may transmit the data received after the decrease in the transmission rate of the application with priority from the sub-line.

Further effects and modifications can be easily derived by those skilled in the art. Therefore, the broader aspects of the present disclosure are as described above, and are not limited to the specific details and representative embodiments described above. Accordingly, various changes can be made without departing from the gist or scope of the general inventive concept defined by the appended claims and equivalent thereof.

What is claimed is:

1. A communication system comprising:
an information processing terminal configured to transmit data received from an application; and
an information processing apparatus configured to execute processing based on the data received from the information processing terminal, wherein:
the information processing terminal includes a first processor configured to
determine whether a transmission rate of the application is decreased, and
transmit, in a case where determination is made that the transmission rate of the application is decreased, data received after the decrease in the transmission rate of the application with priority over data that is not transmitted and is received before the decrease in the transmission rate of the application; and
the information processing apparatus includes a second processor configured to receive the data after the decrease in the transmission rate of the application from the information processing terminal and execute processing based on the received data.

2. An information processing terminal configured to transmit data received from an application to an information processing apparatus, the information processing terminal comprising a processor configured to:
determine whether a transmission rate of the application is decreased; and
transmit, in a case where determination is made that the transmission rate of the application is decreased, data received after the decrease in the transmission rate of the application with priority over data that is not transmitted and is received before the decrease in the transmission rate of the application.

3. The information processing terminal according to claim 2, wherein the processor is configured to determine that the transmission rate of the application is decreased, in a case where a reception rate of the information processing terminal is decreased.

4. The information processing terminal according to claim 2, wherein the processor is configured to determine that the transmission rate of the application is decreased, in a case where notification that the transmission rate of the application is decreased is received from the application.

5. The information processing terminal according to claim 2, wherein the processor is configured to determine that the transmission rate of the application is decreased, in a case where a reception rate of the information processing terminal exceeds a bandwidth of a network between the information processing terminal and the information processing apparatus.

6. An information processing system comprising:
the information processing terminal according to claim 4; and
a terminal device on which the application is installed,
wherein, in a case where line congestion information is received from the information processing terminal, the application is configured to:
stop transmission at a current transmission rate;
transmit the notification that the transmission rate of the application is decreased to the information processing terminal; and
resume transmission by decreasing the transmission rate.
